(19) United States
(12) Patent Application Publication
(10) Pub. No.: US 2008/0290542 A1
(43) Pub. Date: Nov. 27, 2008

(54) Hot Runner Having Temperature Sensor for Controlling Nozzle Heater

(75) Inventor: George Olaru, Georgetown (CA)

Correspondence Address: MOLD-MASTERS (2007) Limited, 233 ARMSTRONG AVENUE, INTELLECTUAL PROPERTY DEPARTMENT, GEORGETOWN, ON, L7G-4X5, CA

(73) Assignee: Mold-Masters (2007) Limited, Georgetown (CA)

(21) Appl. No.: 12/126,378

(22) Filed: May 23, 2008

Related U.S. Application Data
(60) Provisional application No. 60/940,300, filed on May 25, 2007.

(51) Int. Cl. B29C 47/92

(52) U.S. Cl. 264/40.6; 425/144

(57) ABSTRACT

A hot runner includes a manifold having a manifold channel and a plurality of nozzle coupled to the manifold. The manifold channel includes a plurality of branches and a manifold heater. Each of the plurality of nozzles includes a nozzle channel and a nozzle heater, the nozzle channel for receiving molding material from a branch of the manifold channel and delivering molding material to a mold cavity. At least one temperature sensor is located near the interface of the manifold and at least one of the nozzles. The temperature sensor is connected to a controller and the controller is connected to at least one of the nozzle heaters. The controller controls power to the nozzle heater according to a temperature measured by the temperature sensor.

### CROSS-REFERENCE TO RELATED APPLICATION

This application claims the benefit of U.S. provisional patent application No. 60/940,300 filed May 25, 2007, which is hereby incorporated by reference in its entirety herein.

### BACKGROUND OF THE INVENTION

1. Field of the Invention

The present invention relates to a hot runner of an injection molding apparatus, and, more particularly, to a temperature sensor in the hot runner and a method of controlling a heater.

2. Related Art

Injection molding systems including injection manifolds, hot runner nozzles, and mold cavities are known. In some cases mold cavities have the same size to make identical molded parts simultaneously. In other cases mold cavities have different shapes and sizes to make different parts simultaneously.

Filling mold cavities with the proper amount of molding material (e.g., plastic melt) is still a challenge in many hot runner applications. This is partly because molding material flowing in most hot runner manifolds exhibits an asymmetrical cross-sectional temperature and viscosity pattern. This is partially due to uneven shear stress generated by molding material flowing through the various melt channels.

Temperature, pressure, and dimensional variations in the manifold and in the nozzles can create an uneven filling of mold cavities, even those cavities having the same shape or size. Furthermore, heat loss due to the contact between the manifold and the nozzles with the mold plates also contributes to an uneven filling of the mold cavities.

### SUMMARY OF THE INVENTION

A hot runner includes a manifold having a manifold channel and a plurality of nozzle coupled to the manifold. The manifold channel includes a plurality of branches and a manifold heater. The manifold channel receives molding material from a sprue. Each of the plurality of nozzles includes a nozzle channel and a nozzle heater. The nozzle channel is aligned with an outlet of one of the branches of the manifold channel and receives molding material therefrom. The nozzle channel delivers molding material to a mold cavity. At least one temperature sensor is located near the interface of the manifold and at least one of the nozzles. The temperature sensor is connected to a controller and the controller is connected to at least one of the nozzle heaters. The controller controls power to the nozzle heater according to a temperature measured by the temperature sensor.

### BRIEF DESCRIPTION OF THE FIGURES

Embodiments of the present invention will now be described more fully with reference to the accompanying drawings.

FIG. 1 is a partial section diagram of a hot half according to an embodiment of the present invention.

FIG. 2 is a schematic view of selected components of the hot half of FIG. 1 and a control circuit according to an embodiment of the present invention.

FIG. 3 is a flowchart of a nozzle heater control procedure executed by the control circuit of FIG. 2 according to an embodiment of the present invention.

FIG. 4 is a schematic view of a hot runner for a 32 cavity injection molding system to illustrate another embodiment of the present invention.

FIG. 5 is a sectional diagram of a hot half according to an embodiment of the present invention.

FIG. 6 is a partial section diagram of a portion of a hot half according to an embodiment of the present invention.

FIG. 7 is a sectional diagram of a hot half according to an embodiment of the present invention.

### DETAILED DESCRIPTION OF THE INVENTION

Generally, a hot half is a part of an injection molding apparatus used to deliver heated molding material from an injection molding machine to a mold cavity. Among various plates, a hot half typically includes a heated manifold and one or more nozzles and related components, which together are called a hot runner.

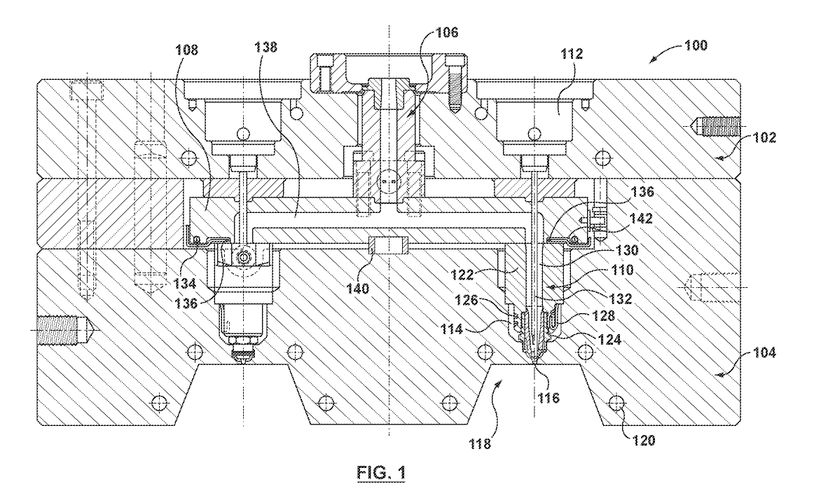

FIG. 1 illustrates a hot half 100 according to an embodiment of the present invention. The hot half 100 includes a back plate 102, a mold plate 104, a sprue 106, a manifold 108, and nozzles 110. By way of example, the hot half 100 has four nozzles (two not shown), but more or fewer can equally be used. Although a valve-gated system is shown, a thermal-gated system could also be used. In addition, the features and aspects described for the other embodiments can be used accordingly with the present embodiment.

The back plate 102 accommodates the sprue 106, which delivers molding material (e.g., plastic melt) to the hot half 100. Actuators 112 are disposed in the back plate 102 for controlling flow of molding material through the nozzles 110.

The mold plate 104 includes wells 114 for accommodating the nozzles 110, mold gates 116 that lead to cavity areas 118, and cooling channels 120. Cavity areas 118 cooperate with other components (not shown) to form mold cavities for producing molded products. More mold plates can be used, and other known components, such as gate inserts, can also be used.

Each nozzle 110 includes a nozzle body 122, a nozzle tip 124, a heater 126, and a temperature sensor 128. The nozzle body 122 and nozzle tip 124 define a nozzle channel 130 running therethrough for delivering molding material to the mold gate 116. The heater 126 is an electrically resistive wire element or the like, and can be wound around the nozzle body 122 as shown. The temperature sensor 128 can be a thermocouple or the like and can be omitted if desired. A valve pin 132 extends from the actuator 112, through the nozzle 110, and to the mold gate 116 to allow opening and closing of the mold gate 116.

The manifold 108 includes a heater 134 and temperature sensors 136. A manifold channel 138 has branches that extend through the manifold 108 from the sprue 106 to the nozzles 110 to deliver molding material to the nozzles 110. The heater 134 is an electrically resistive wire element or the like and serves to heat the manifold 108 and thus heat the molding material within the manifold channel 138. A locating ring 140 locates and seats the manifold 108 on the mold plate 104.

A temperature sensor 136 is provided for each nozzle 110. Each temperature sensor 136 is disposed in a groove 142 of the manifold 108 near the interface of the manifold 108 and the nozzle 110 (i.e., near the outlet of the manifold 108). The temperature sensors 136 can be thermocouples or similar devices that produce an electrical signal based on a temperature measured at a sensing point. In this embodiment, the sensing points of the temperature sensors 136 are positioned as close to the manifold channel 138 as possible, so as to accurately measure the temperature of the molding material therein. Bores could be used instead of grooves, and a groove or bore could be located in the upstream portion of the nozzle body (i.e., the head) instead of in the manifold 108, in which case the sensing point of the temperature sensor 136 should be located as close as possible to the nozzle channel 130, so as to accurately measure the temperature of the molding material therein. Although various locations for each temperature sensor 136 are acceptable, and indeed some will be more practical than others, it is preferable to place the temperature sensor 136 at a location downstream of where the flowing molding material is mainly influenced by the manifold 108 but upstream of where the molding material comes mainly under the influence of the nozzle heater 126. In this embodiment, such a location is in the manifold 108 near the interface of the manifold 108 and the nozzle 110. Another example of such a location for the temperature sensor 136 is in the nozzle 110 or in the manifold 108 upstream of the nozzle heater 126, and near enough the molding material to measure the temperature of the molding material. The temperature sensor 136 is used to control the nozzle heater 126.

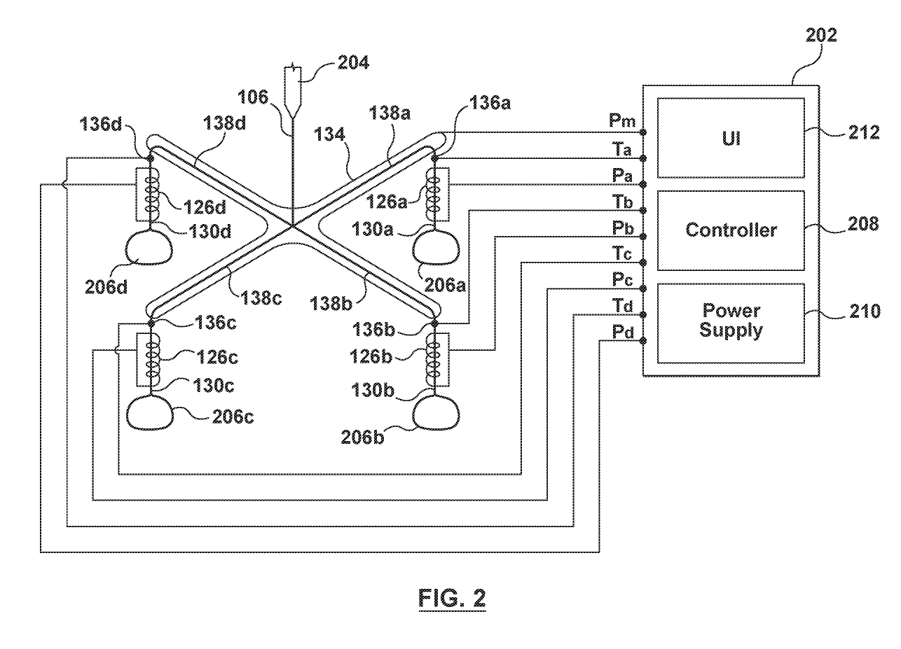

FIG. 2 illustrates a schematic view of selected components of the hot half 100 and a control circuit 202 according to an embodiment of the present invention. The manifold channel 138 of FIG. 1 is shown as having four branches 138a-d, one for each nozzle 110a-d and corresponding nozzle channel 130a-d and nozzle heater 126a-d. As can be seen, the shape of the manifold heater 134 is unsymmetrical with respect to the branches 138a-d. At the outlet of each branch 138a-d is a respective temperature sensor 136a-d. Also shown in FIG. 2 are a nozzle 204 of an injection molding machine that feeds molding material into the sprue 106 and mold cavities 206a-d, which need not have the same shape or size.

The control circuit 202 is connected to the nozzle heaters 126a-d and the temperature sensors 136a-d and is optionally connected to the manifold heater 134. The temperature measurements made by the temperature sensors 136a-d enter the control circuit 202 as Ta-d, and the control circuit 202 outputs power to the nozzle heaters 126a-d as Pa-d. The control circuit 202 can also output power to the manifold heater 134 as Pm. It should be noted that the connections shown in FIG. 2 are schematic, and more than one lead is typically required for a heater or temperature sensor.

The control circuit 202 includes a controller 208, a power supply 210, and a user interface 212. The controller 208 is a chip or circuit that includes a processor and/or logic. The temperature measurements Ta-d are fed into the controller 208. The power supply 210 is connected to the controller 208 and supplies electrical power to the heaters 126a-d based on output from the controller 208. The user interface 212 is optional and is connected to the controller 208. The user interface 212 can include input/output devices such as a keyboard, display screen, touch screen, mouse, and the like. The control circuit 202 can include other well-known components such as filters, memory, digital signal processors, and A/D and D/A converters, and these are not shown for clarity. The control circuit 202 can be digital, analog, or a combination of such. The control circuit 202 can be a computer.

Generally, the effects of the nozzle heaters 126a-d are known and consistent between nozzles 110, while the heating or cooling of molding material in the manifold 108 is usually unknown and unpredictable. Therefore, measuring the temperature of the molding material at the outlet of the manifold 108 with the sensors 136a-d is a direct way to determine the influence of the manifold 108 on the various branches of molding material. And independently adjusting the nozzle heaters 126a-d based on the measured temperatures Ta-d is a direct way to compensate for uneven influence of the manifold 108.

The controller 208 uses the temperature measurements Ta-d to control the power Pa-d supplied to each nozzle heater 126a-d to adjust the heat output of each nozzle heater 126a-d. The controller 208 compensates for the fact that the temperatures of the molding material at the various branches 138a-d of the manifold channel 138 as measured by the temperature sensors 136a-d are likely to be different. Such differences can be a result of many factors including the temperature distribution of the incoming molding material at the sprue 106, properties of the molding material (e.g., viscosity), different shearing of the molding material in the branches 138a-d of the manifold channel 138, uneven heating of different branches 138a-d of the manifold channel 138 due to geometry of the manifold channel 138, uneven layout of the manifold heater 134 (as shown in FIG. 2), the number of nozzles and cavities (i.e., cavitation), and heat exit paths such as the locating ring 140, valve pin bushings, bolts, and the like.

Generally, the controller 208 increases the power to a given nozzle heater 126a-d when the molding material temperature measured Ta-d by the respective temperature sensor 136a-d is too low. Likewise, the controller 208 decreases the power to a given nozzle heater 126a-d when the molding material temperature measured Ta-d by the respective temperature sensor 136a-d is too high. A set temperature can be used to determine whether a measured temperature is too high to too low. The set temperature can be predetermined based on molding parameters (e.g., molding material properties, cavity geometry and filling characteristics, etc.). Set temperatures for each nozzle 110 can be stored in the controller 208 and inputted and modified via the user interface 212. All the nozzles 110 can have different set temperatures or certain nozzles 110 can share the same set temperature. If temperature sensors 128 are provided near the tip portion of each nozzle 110, temperature measurements here can be used to confirm that the nozzle heater 126a-d is working and was adequately adjusted and to determine if there are any local differences from one cavity 206a-d to another.

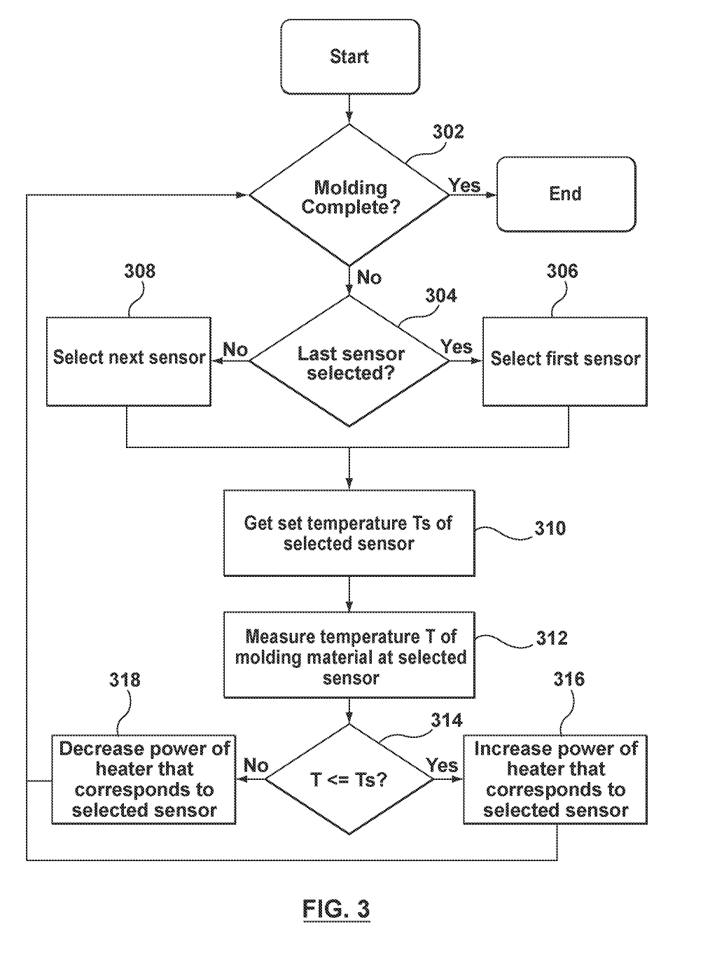

FIG. 3 shows a flowchart describing a nozzle heater control procedure executed by the control circuit 208 according to an embodiment of the present invention. In step 302, the controller 208 checks that molding is still ongoing. This check can be performed by the controller 208 receiving a signal from a molding controller, if the controller 208 is not itself the molding controller 208. Next, in steps 304-306, the controller 208 selects the next temperature sensor (e.g., sensor 136a-d) or cycles back to the first one if the last one was just processed. The controller 208 then gets (e.g., obtains from memory) the set temperature (Ts) of the selected temperature sensor 136a-d, in step 310. Next, in step 312, the controller 208 measures the temperature (T) of the molding material at the selected sensor 136a-d. The controller 208 then compares the measured temperature (T) with the set temperature (Ts), in step 314, to determine whether the power of the corresponding nozzle heater 126a-d should be increased (step 316) or decreased (step 318). The amount of increase or decrease of power can be fixed, can depend on the magnitude of difference between the measured temperature (T) and the set temperature (Ts), or can obey some other formula. Thus, the nozzle heater control procedure allows the nozzle heaters 126a-d to be independently controlled based on the temperature of the molding material as measured by the temperature sensors 136a-d located at the outlets of the manifold channel branches 138a-d.

It should be noted that in the nozzle heater control procedure described above, the steps may be performed in a different order, individual steps may be combined or split into smaller steps, and additional steps can be made to intervene.

To store and execute the nozzle heater control procedure described above, the controller 208 can use hardware, firmware, software, or a combination of these. The controller 208 can execute the nozzle heater control procedure continuously (e.g., in real-time) or discretely (i.e., one or several times per molding cycle, when the mold gate 116 is opened and/or closed).

Since the temperature sensors 136a-d measure temperatures of the molding material after the molding material has passed through the branches 138a-d of the manifold 108, and since the nozzle heaters 126a-d are adjusted according to these measured temperatures, the uneven influence of manifold 108 on the temperature of the molding material can be reduced. As such, better melt balancing is achieved and the cavities 206a-d will fill more evenly, resulting in better quality molded products.

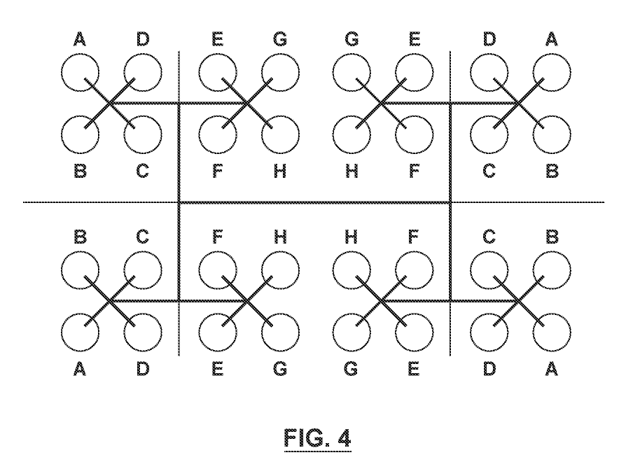

FIG. 4 shows a schematic illustration of a hot runner for a 32 cavity injection molding system to illustrate another embodiment of the present invention. Nozzles are represented by circles and channels for molding material are represented by thick lines. This embodiment is identical to the embodiment of FIGS. 1-3 except for two main aspects. First, the number of nozzles and associated components is increased. Second, the geometry of the system allows for a reduction in the number of temperature sensors (ref. 136 of FIG. 1) by symmetry. Specifically, because of the geometry of the channels, like labeled nozzles (i.e., A to H) will generally contain molding material with the same shear profile. That is, nozzles labeled A will all have the same shear profile, as will those nozzles labeled B, etc. If heating effects besides shear (i.e., manifold heater placement, heat exit points, etc) are mitigated or can be safely ignored, then fewer temperature sensors need to be used. One temperature sensor for each different nozzle location A-H is adequate. Therefore, the advantages of the embodiment described in FIGS. 1-3 can be realized in molds with more cavities without needing that many more temperature sensors. In this example, symmetry allows the temperature of 32 different branches of molding material to be controlled with eight temperature sensors. That is, four nozzle heaters are controlled by one temperature sensor.

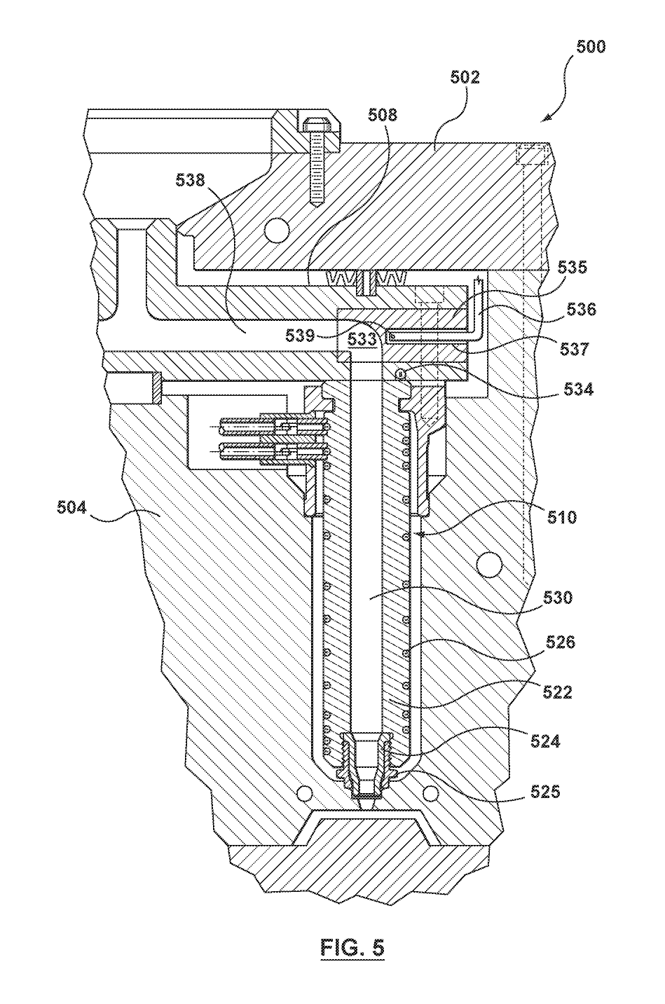

FIG. 5 illustrates a portion of a hot half 500 according to an embodiment of the present invention. The hot half 500 includes a back plate 502, a mold plate 504, a manifold 508, and nozzles 510 (one shown, but more can be used). The back plate 502 and mold plate 504 can be as described in the embodiment of FIGS. 1-3, and the features and aspects described for the other embodiments can be used accordingly with the present embodiment.

Each nozzle 510 includes a nozzle body 522, a nozzle tip 524, a tip retainer 525, and a heater 526. The nozzle body 522 and nozzle tip 524 define a nozzle channel 530 running therethrough for delivering molding material to a mold cavity. The heater 526 is an electrically resistive wire element or the like, and can be wound around the nozzle body 522 as shown.

The manifold 508 includes a heater 534 and a manifold channel 538 that extends through the manifold 508 to deliver molding material to the nozzle 510. A plug 535 having a plug channel 533 is inserted into the manifold 508 to direct the branch of the manifold channel 538 towards the nozzle 510. The heater 534 is an electrically resistive wire element or the like and serves to heat the manifold 508 and thus heat the molding material within the manifold channel 538.

A temperature sensor 536 is provided in a bore 537 of the plug 535. The temperature sensor is near the interface of the manifold 508 and the nozzle 510 (i.e., near the outlet of the manifold 508). The temperature sensor 536 can be a thermocouple or similar device that produces an electrical signal based on a temperature measured at a sensing point 539. In this embodiment, the sensing point 539 of the temperature sensor 536 is positioned as close to the manifold channel 538 as possible, so as to accurately measure the temperature of the molding material therein. A groove in the plug 535 could be used instead of the bore 537. The temperature sensor 536 is used to control the nozzle heater 526.

Control of the nozzle heater 526 with the temperature sensor 536 is the same as described above with reference to FIGS. 1-3.

Locating the temperature sensor 536 in the plug 535 is equally as acceptable as locating the temperature sensor 136 in the groove 142 of the manifold 108 as shown in FIG. 1.

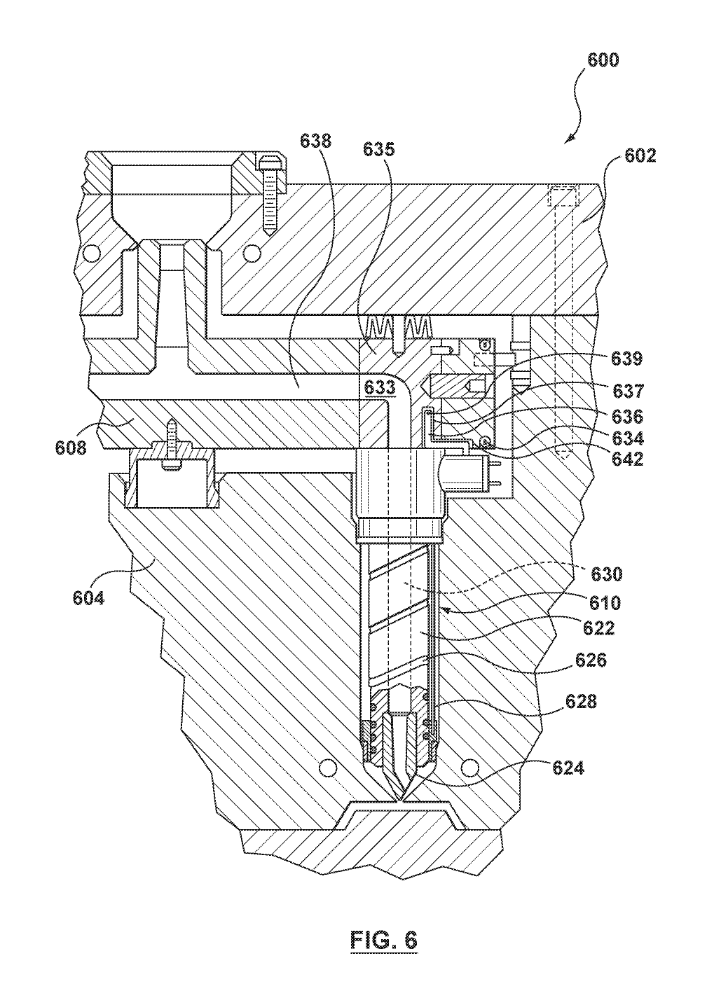

FIG. 6 illustrates a portion of a hot half 600 according to an embodiment of the present invention. The hot half 600 includes a back plate 602, a mold plate 604, a manifold 608, and nozzles 610 (one shown, but more can be used). The back plate 602 and mold plate 604 can be as described in the embodiment of FIGS. 1-3, and the features and aspects described for the other embodiments can be used accordingly with the present embodiment.

Each nozzle 610 includes a nozzle body 622, a nozzle tip 624, a heater 626, and a temperature sensor 628. The nozzle body 622 and nozzle tip 624 define a nozzle channel 630 running therethrough for delivering molding material to a mold cavity. The heater 626 is an electrically resistive wire element or the like, and can be wound around the nozzle body 622 as shown. The temperature sensor 628 can be a thermocouple or the like and can be omitted if desired.

The manifold 608 includes a heater 634 and a manifold channel 638 that extends through the manifold 608 to deliver molding material to the nozzle 610. A plug 635 having a plug channel 633 is inserted into the manifold 608 to direct the branch of the manifold channel 638 towards the nozzle 610. The heater 634 is an electrically resistive wire element or the like and serves to heat the manifold 608 and thus heat the molding material within the manifold channel 638. The manifold 608 further includes a groove 642.

A temperature sensor 636 is provided in a bore 637 of the plug 635 and the groove 642 of the manifold 608. The temperature sensor is near the interface of the manifold 608 and the nozzle 610 (i.e., near the outlet of the manifold 608). The temperature sensor 636 can be a thermocouple or similar device that produces an electrical signal based on a temperature measured at a sensing point 639. In this embodiment, the sensing point 639 of the temperature sensor 636 is positioned as close to the manifold channel 638 as possible, so as to accurately measure the temperature of the molding material therein. A groove in the plug 635 or a bore in the manifold 608 could be used instead of the bore 637 or groove 642. The temperature sensor 636 is used to control the nozzle heater 626.

Control of the nozzle heater 626 with the temperature sensor 636 is the same as described above with reference to FIGS. 1-3.

Locating the temperature sensor 636 in the plug 635 is equally as acceptable as locating the temperature sensor 136 in the groove 142 of the manifold 108 as shown in FIG. 1.

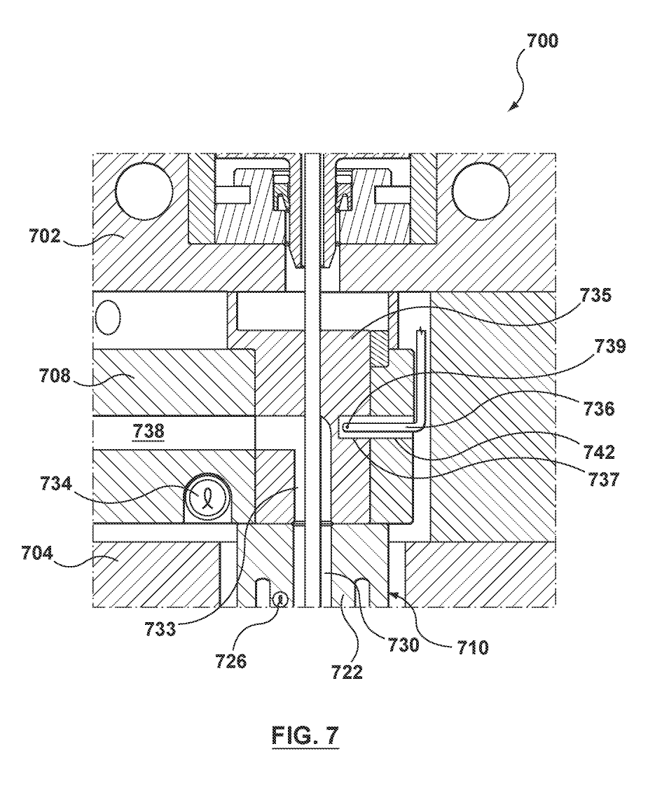

FIG. 7 illustrates a portion of a hot half 700 according to an embodiment of the present invention. The hot half 700 includes a back plate 702, a mold plate 704, a manifold 708, and nozzles 710 (one partially shown, but more can be used). The back plate 702 and mold plate 704 can be as described in the embodiment of FIGS. 1-3, and the features and aspects described for the other embodiments can be used accordingly with the present embodiment.

Each nozzle 710 includes a nozzle body 722, a nozzle tip (not shown), and a heater 726. The nozzle body 722 defines a nozzle channel 730 running therethrough for delivering molding material to a mold cavity. The heater 726 is an electrically resistive wire element or the like, and can be embedded in the nozzle body 722 as shown.

The manifold 708 includes a heater 734 and a manifold channel 738 that extends through the manifold 708 to deliver molding material to the nozzle 710. A valve pin bushing 735 having a bushing channel 733 is inserted into the manifold 708 to direct the branch of the manifold channel 738 towards the nozzle 710. The heater 734 is an electrically resistive wire element or the like and serves to heat the manifold 708 and thus heat the molding material within the manifold channel 738. The manifold 708 further includes a bore 742.

A temperature sensor 736 is provided in a bore 737 of the valve pin bushing 735 and the bore 742 of the manifold 708. The temperature sensor is near the interface of the manifold 708 and the nozzle 710 (i.e., near the outlet of the manifold 708). The temperature sensor 736 can be a thermocouple or similar device that produces an electrical signal based on a temperature measured at a sensing point 739. In this embodiment, the sensing point 739 of the temperature sensor 736 is positioned as close to the manifold channel 738 as possible, so as to accurately measure the temperature of the molding material therein. A groove in the valve pin bushing 735 or manifold 708 could be used instead of the bore 737 or bore 742. The temperature sensor 736 is used to control the nozzle heater 726.

Control of the nozzle heater 726 with the temperature sensor 736 is the same as described above with reference to FIGS. 1-3.

Locating the temperature sensor 736 in the valve pin bushing 735 is equally as acceptable as locating the temperature sensor 136 in the groove 142 of the manifold 108 as shown in FIG. 1.

Although preferred embodiments of the present invention have been described, those of skill in the art will appreciate that variations and modifications may be made without departing from the spirit and scope thereof as defined by the appended claims. All patents and publications discussed herein are incorporated in their entirety by reference thereto.

What is claimed is:

1. A hot runner, comprising:
a manifold having a manifold channel with a plurality of branches and a manifold heater, the manifold channel for receiving molding material from a sprue;
a plurality of nozzles coupled to the manifold, each nozzle having a nozzle channel and a nozzle heater, the nozzle channel for receiving molding material from a branch of the manifold channel and delivering molding material to a mold cavity;
at least one temperature sensor located near the interface of the manifold and at least one of the nozzles; and
a controller connected to the temperature sensor and to the nozzle heater of the at least one nozzle, the controller controlling power to the nozzle heater of the at least one nozzle according to a temperature measured by the temperature sensor.

2. The hot runner according to claim 1, wherein the at least one temperature sensor is disposed in a groove or a bore in the manifold adjacent an outlet of the manifold channel.

3. The hot runner according to claim 1, further comprising a plug having a plug channel disposed in the manifold, wherein the temperature sensor is disposed in a bore or a groove in the plug adjacent the plug channel.

4. The hot runner according to claim 1, further comprising a valve pin bushing having a bushing channel disposed in the manifold, wherein the temperature sensor is disposed in a bore or a groove in the bushing adjacent the bushing channel.

5. The hot runner according to claim 1, further comprising:
a valve pin bushing having a bushing channel disposed in the manifold, wherein the bushing channel aligns with one of the plurality of branches of the manifold channel and one of the nozzle channels; and
a valve pin disposed at least partially within the bushing channel and the nozzle channel,
wherein the at least one temperature sensor is disposed in a bore or a groove in the valve pin bushing.

6. The hot runner according to claim 5, further comprising a bore or a groove in the manifold aligned with the bore or the groove in the bushing.

7. The hot runner according to claim 1, wherein the temperature sensor is disposed in a bore or a groove in a head of the nozzle.

8. A hot runner, comprising:
a manifold having a manifold channel with a plurality of branches and a manifold heater, the manifold channel for receiving molding material from a sprue, each of the branches of the manifold channel having a least one bend;
a plurality of nozzles coupled to the manifold, each nozzle having a nozzle channel and a nozzle heater having an upstream end and a downstream end, the nozzle channel for receiving molding material from a branch of the manifold channel and delivering molding material to a mold cavity;
a temperature sensor located downstream of the bend in one of the branches of the manifold channel and upstream of the upstream end of one of the nozzle heaters; and
a controller connected to the temperature sensor and to the nozzle heater, the controller controlling power to the nozzle heater according to a temperature measured by the temperature sensor.

9. The hot runner according to claim 8, wherein the at least one temperature sensor is disposed in a groove or a bore in the manifold adjacent an outlet of the manifold channel.

10. The hot runner according to claim 8, further comprising a plug having a plug channel disposed in the manifold, wherein the temperature sensor is disposed in a bore or a groove in the plug adjacent the plug channel.

11. The hot runner according to claim 8, further comprising a valve pin bushing having a bushing channel disposed in the manifold, wherein the temperature sensor is disposed in a bore or a groove in the bushing adjacent the bushing channel.

12. The hot runner according to claim 8, further comprising:
a valve pin bushing having a bushing channel disposed in the manifold, wherein the bushing channel aligns with one of the plurality of branches of the manifold channel and one of the nozzle channels; and
a valve pin disposed at least partially within the bushing channel and the nozzle channel,
wherein the at least one temperature sensor is disposed in a bore or a groove in the valve pin bushing.

13. The hot runner according to claim 12, further comprising a bore or a groove in the manifold aligned with the bore or the groove in the bushing.

14. The hot runner according to claim 8, wherein the temperature sensor is disposed in a bore or a groove in a head of the nozzle.

15. A method for controlling a heater of a nozzle of a hot runner, comprising the steps of:
providing a nozzle having a nozzle channel and a nozzle heater, the nozzle channel for receiving molding material from a manifold channel of a manifold and delivering molding material to a mold cavity;
providing a temperature sensor located near the interface of the nozzle and the manifold; and
controlling power to the nozzle heater according to a temperature measured by the temperature sensor.

16. The method according to claim 15, wherein the at least one temperature sensor is disposed in a groove or a bore in the manifold adjacent an outlet of the manifold channel.

17. The method according to claim 15, further comprising a plug having a plug channel disposed in the manifold, wherein the temperature sensor is disposed in a bore or a groove in the plug adjacent the plug channel.

18. The method according to claim 15, further comprising a valve pin bushing having a bushing channel disposed in the manifold, wherein the temperature sensor is disposed in a bore or a groove in the bushing adjacent the bushing channel.

19. The method according to claim 15, further comprising:
a valve pin bushing having a bushing channel disposed in the manifold, wherein the bushing channel aligns with one of the plurality of branches of the manifold channel and one of the nozzle channels; and
a valve pin disposed at least partially within the bushing channel and the nozzle channel,
wherein the at least one temperature sensor is disposed in a bore or a groove in the valve pin bushing.

20. The method according to claim 19, further comprising a bore or a groove in the manifold aligned with the bore or the groove in the bushing.

21. The method according to claim 15, wherein the temperature sensor is disposed in a bore or a groove in a head of the nozzle.
